(19) United States
(12) Patent Application Publication
(10) Pub. No.: US 2013/0009823 A1
(43) Pub. Date: Jan. 10, 2013

(54) SYSTEMS AND METHODS FOR SHORT BASELINE, LOW COST DETERMINATION OF AIRBORNE AIRCRAFT LOCATION

(75) Inventor: Guoqing Wang, Beijing (CN)

(73) Assignee: HONEYWELL INTERNATIONAL INC., Morristown, NJ (US)

(21) Appl. No.: 13/582,400

(22) PCT Filed: Mar. 17, 2010
(86) PCT No.: PCT/CN10/00323

§ 371 Date: Aug. 31, 2012

(51) Int. Cl. G01S 5/02

(52) U.S. Cl. 342/464

(57) ABSTRACT

Systems and methods are operable to locate an airborne aircraft (108). The method communicates an interrogation signal to an Air Traffic Control Radar Beacon System (ATCRBS) or mode S transponder equipped airborne aircraft (108) and to a plurality of slave ground receivers (104a-104i) from a master ground station (102). Each of the slave ground receivers (104a-104i) receives the interrogation signal from the master ground station (102) and synchronizes its system time with the master ground station (102), respectively. The master ground station (102) and the plurality of slave ground receivers (104a-104i) receive interrogation reply signals (106,110a-110i) from the airborne aircraft (108). The master ground station (102) determines a time of arrival (TOA) of the reply signal at master ground station (102) and respective ones of the TOA of the reply signal received at the slave ground receivers (104a-104i). A location (116) of the airborne aircraft (108) is determined based on at least one of a multilateration calculation and an elliptical calculation using at least the three TOAs.

### BACKGROUND OF THE INVENTION

Demand for air travel is forecast to continue to increase at an extraordinary rate in both mature and developing markets. In the U.S., some forecasts indicate that passenger numbers may increase by up to 140% over the next twenty years with aircraft movements increasing up to threefold, depending on the mix of small and larger aircraft. In Europe, some organizations predict similar challenges, with the number of flights predicted to increase by 150% over the same period. In developing markets such as China, Asia-Pacific, and South America the growth is expected to be even greater.

Radar control is an important method of providing air traffic control services. Such radar control improves the safety of air traffic, and increases the airspace capacity, compared to airspace regions that use non-radar aircraft procedure control. Air traffic radar surveillance is limited partially because of the cost of the ground-based surveillance equipment and facilities, and the fact that there are varying types of air traffic control equipment installed in aircraft. Many aircraft have no installed air traffic control equipment.

Further, the reliability of air traffic surveillance radar systems is also critical to maintain a high efficiency of air traffic controlling. A failure of air traffic surveillance radar may disrupt normal flight operations. Further, such failures may pose a hazard to aircraft that rely on supplemental control provided by the air traffic surveillance radar systems.

Further, some geographic regions have poor or no air traffic surveillance radar systems. For example, Western and Northern parts of China have poor air traffic radar coverage. And, there will be increasing demands of air traffic radar coverage because of new airport construction plans in many parts of China. Up to forty-five new airports are planned for construction in China during the eleventh (11^{th}) 5-year plan, and fifty-two new airports are planned from year 2011 to 2020. These plans do not include airports for general aviation, which will further increase air traffic.

Various air traffic surveillance systems are available for air traffic control. Automatic dependent surveillance-broadcast (ADS-B) systems installed on aircraft periodically communicate information that can be used to determine airborne aircraft location. However, the location information provided in such communications may not be reliable under all conditions. Mode C/S transponders installed on aircraft communicate information that can be used to determine aircraft location in response to receiving interrogation signals, this method depends on expensive Secondary Surveillance Radar (SSR) ground facility.

Some prior art aircraft location systems employ global positioning system (GPS) information. However, such systems will fail when GPS information is unavailable, or is in error. Further, some geographic regions do not have access to GPS information.

Accordingly, there is a need to provide low cost, high accuracy and robust air traffic surveillance systems for airports that are not equipped with traditional radar facilities.

### SUMMARY OF THE INVENTION

Systems and methods of locating airborne aircraft are disclosed. An exemplary embodiment communicates an interrogation signal to an Air Traffic Control Radar Beacon System (ATCRBS) or mode S transponder equipped airborne aircraft and to a plurality of slave ground receivers from a master ground station. Each of the slave ground receivers receive the interrogation signal from the master ground station and synchronize their system time with the master ground station, respectively. The master ground station and the plurality of slave ground receivers receive interrogation reply signals from the airborne aircraft. The master ground station determines a time of arrival (TOA) of the reply signal at master ground station and respective ones of the TOA of the reply signal received at the slave ground receivers. A location of the airborne aircraft is determined based on at least one of a multilateration calculation and an elliptical calculation using at least three TOAs.

Additionally, or alternatively, the master ground station and plurality slave ground receivers may also passively listen to the automatic dependent surveillance-broadcast (ADS-B) squitters from an ADS-B capable Mode S transponder equipped airborne aircraft, determine each time TOA of the squitter signal at master ground station and the slave ground receivers, decode the position message from received position squitters and determine the aircraft position. The TOAs are used to verify the airborne aircraft reported position.

### BRIEF DESCRIPTION OF THE DRAWINGS

Preferred and alternative embodiments are described in detail below with reference to the following drawings:

FIG. 1 is a conceptual diagram illustrating operation of an embodiment of the short baseline multilateration system;

FIG. 2 is a block diagram of exemplary components residing in a master ground station; and

FIG. 3 is a block diagram of exemplary components residing in one of a plurality of slave ground receivers.

### DETAILED DESCRIPTION OF THE PREFERRED EMBODIMENT

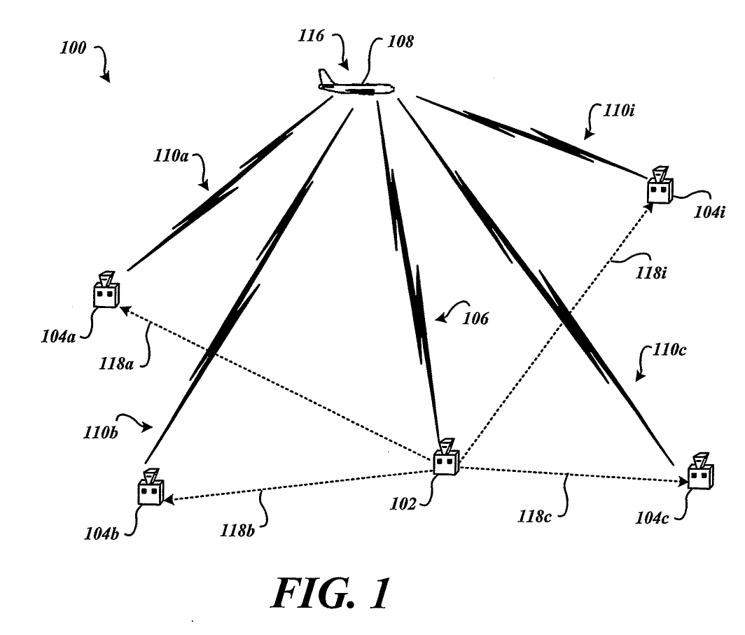

FIG. 1 is a conceptual diagram illustrating operation of an embodiment of the short baseline positioning system 100. An exemplary embodiment of the short baseline positioning system 100 comprises a master ground station 102 and a plurality of slave ground receivers 104a-104i.

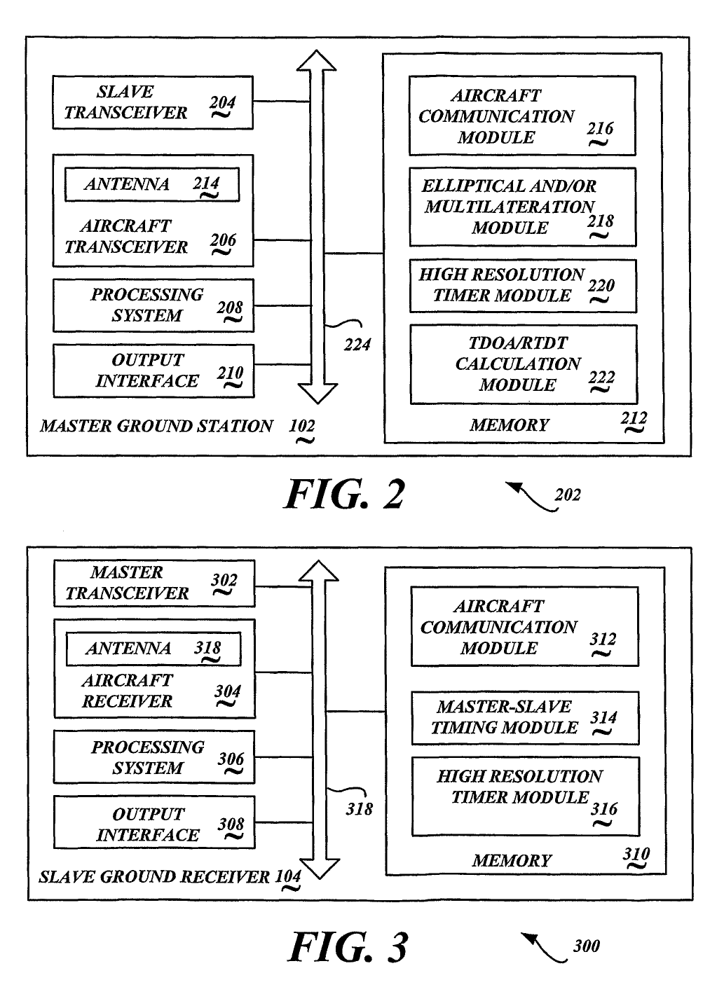

FIG. 2 is a block diagram of exemplary components 202 residing in the master ground station 102. The components 202 of the master ground station 102 comprise a slave transceiver 204, a ground station aircraft transceiver 206, a processing system 208, an output interface 210, a memory 212, and an antenna 214. In an exemplary embodiment, the antenna 214 emits an interrogation signal to the aircraft 108 and receives aircraft replies and/or squitters. The antenna 214 may be an omni-directional antenna. Portions of the memory 212 are configured to store an aircraft communication module 216, an elliptical and/or multilateration module 218, an optional high resolution timer module 220, and a time difference of arrival (TDOA) and/or round trip delay time (RTDT) calculation module 222. The optional high resolution timer module 220 provides nanosecond level timing for acceptable bearing resolution. The master station 102 can have more components and may be more complex than its respective slave sites 104.

The slave transceiver 204, the ground station aircraft transceiver 206, the processing system 208, the output interface 210, and the memory 212 are communicatively coupled to a communication bus 224, thereby providing connectivity between the above-described components. In alternative embodiments of the short baseline positioning system 100, the above-described components may be communicatively coupled to each other in a different manner. For example, one or more of the above-described components may be directly coupled to the processing system 208, or may be coupled to the processing system 208 via intermediary components (not shown). Further, additional components (not shown) may be included in alternative embodiments of the master ground station 102.

FIG. 3 is a block diagram of exemplary components 300 residing in one of the plurality of slave ground receivers 104. The components 300 of the exemplary slave ground receiver 104 comprise a master transceiver 302, an aircraft receiver 304, a processing system 306, an optional output interface 308, and a memory 310. In an exemplary embodiment, portions of the memory 310 are configured to store an aircraft communication module 312, and a master-slave timing module 314. Some embodiments may include an optional high resolution timer module 316. Modules 312, 314, and/or 316 may be integrated with each other and/or may be integrated with other modules (not shown) in alternative embodiments. The aircraft receiver 304 may include an antenna 318. The antenna 214 may be an omni-directional antenna. Preferably, the slave ground receiver 104 should be as simple as possible so as to easily expand the number of slave receivers 104 without too much additional expense, thereby significantly improving the aircraft location resolution accuracy.

The master transceiver 302, the aircraft receiver 304, the processing system 306, the user interface 308, and the memory 310 are communicatively coupled to a communication bus 318, thereby providing connectivity between the above-described components. In alternative embodiments of the short baseline positioning system 100, the above-described components may be communicatively coupled to each other in a different manner. For example, one or more of the above-described components may be directly coupled to the processing system 306, or may be coupled to the processing system 306 via intermediary components (not shown). Further, additional components (not shown) may be included in alternative embodiments of the slave ground receiver 104.

It is appreciated that one or more various signal communicating systems may reside in a particular aircraft 108. For example, the aircraft 108 may be equipped with Mode A or Mode C signal transponders. The Mode A/C transponder transmits a reply signal in response to detecting a Mode A/C interrogation signal incident on the aircraft 108 emitted by the aircraft transceiver 206 of the master ground station 102, commonly referred to as a “squawk” signal or the like. The mode C signal includes barometric pressure altitude information.

Alternatively, or additionally, the aircraft 108 may include a Mode S type transponder that is responsive to a Mode S interrogation signal emitted from the aircraft transceiver 206 residing at the master ground station 102. The Mode S interrogation signal includes a unique identifier assigned to the aircraft 108 that elicits an interrogation reply signal from the aircraft 108. The aircraft 108 emits the interrogation reply signal in response to receiving an interrogation signal having its unique identifier. The mode S signal includes barometric pressure altitude information.

Some aircraft 108 may include automatic dependant surveillance-broadcast (ADS-B) capabilities that incorporate global positioning system (GPS) location information. An airborne ADS-B capable Mode S transponder spontaneously emits RF signals, known as squitters. Some squitters include encoded aircraft position information. However, such information might not be available or reliable when GPS signals are unavailable, in error, or under intentional spoof. In situations where the GPS location information is available, the GPS location information may be used for location verification after multilateration and/or elliptical calculated aircraft location is determined based on time of arrivals (TOAs) of signals received at the master ground station 102 and the slave ground receivers 104. Active Mode S interrogations are preferably transmitted to the aircraft 108 when such location verification fails.

In an exemplary embodiment, the master ground station 102 communicates an interrogation signal to the aircraft 108. The radar signal or other suitable interrogation signal is emitted from the antenna 214 of the aircraft transceiver 206. For example, a Whisper-Shout interrogation signal sequence is transmitted for Mode A/C transponder equipped aircrafts. The Whisper-Shout interrogation sequence is transmitted periodically, such as, but not limited to, every second (even through there are no airborne aircraft 108 in the vicinity of the master ground station 102). Alternatively, or additionally, a Mode S interrogation is transmitted for a non-ADS-B capable Mode S transponder equipped aircraft 108, or for an ADS-B capable Mode S transponder equipped aircraft 108 which failed in the above-described location verification.

In response, a transponder (not shown) on the aircraft 108 communicates an interrogation reply signal 106 that is received by the aircraft transceiver 206 at the master ground station 102. The control of generating the interrogation signal and receiving the interrogation reply signal 106 is managed by the processing system 208 executing the aircraft communication module 216. Processing system 208 may additionally be, or integrated with, a video processing system.

The interrogation signal emitted from master ground station 102 to the airborne aircraft 108 further acts as timing signals 118a-118i. The timing signals 118a-118i may be received by aircraft receiver 304 on slave ground receivers 104, or may be received by a dedicated receiver. The control of generating the interrogation signal, as well as the timing signals 118a-118i, is managed by the processing system 208 executing the master-slave timing module 220 and the aircraft communication module 216. In an exemplary embodiment, the interrogation signal transmitting is carefully scheduled at pre-determined time marks, recorded as the Time Of Transmit (TOT).

Accurate determination of the location 116 of the aircraft 108 is predicated, in part, on the timing signals 118a-118i that are communicated from the master ground station 102 to the plurality of slave ground receivers 104a-104i. The timing signals 118a-118i are used to synchronize the system time of the master-slave timing module 314 at the slave receivers 104a-104i, respectively.

For example, the exact time that a particular the timing signal 118a is received by slave ground receiver 104a is TOT+Offset_{SaM}, where the Offset_{SaM} is the time that the timing signal travels from master ground station 102 to the slave ground receiver 104a. The exact time that the timing signal 118b is received by slave ground receiver 104b is TOT+Offset_{SbM}, where the Offset_{SbM} is the time that the timing signal travels from master ground station 102 to the slave ground receiver 104b. The exact time that the timing signal 118i is received by slave receiver 104i is TOT+Offset_{SiM}, where the Offset_{SiM} is the time that the timing signal travels from master ground station 102 to the slave ground receiver 104i. The TOT includes a specially defined time mark that is recognized and tracked by the slave ground receivers 104a-104i. The timer of master-slave timing module 314 at the slave ground receiver 104 may be frequently synchronized by use of the timing signals 118. In an exemplary embodiment, the control of receiving the timing signals 118a-118i and time synchronization are managed by the aircraft receiver 304 executing the master-slave timing module 314.

Offset_{SaM}, Offset_{SbM}, and offset_{SiM} are known fixed values once the installation of the short baseline positioning system 100 is completed. That is, since the location of each of the slave ground receivers 104a-104i with respect to the master ground station 102 is precisely known, the offsets can be precisely determined.

In the various embodiments, a short baseline distance between the master ground station 102 and the slave ground receivers 104a-104i enable communication of highly aligned timing signals. Further, the electronic components 202, 300 are under similar temperature/humidity operating conditions. Thus, the components 202, 300 will have substantially identical response times for receiving and processing the interrogation reply signals 106, 110a-110i. Accordingly, precise TOA information is available for determination of the location 116.

In an exemplary embodiment, the short baseline distance is on the order of two hundred (200) meters. Accordingly, embodiments of the short baseline positioning system 100 may be fit within, or in proximity to, a medium to large scale airport. Embodiments may also be configured for installation at small general aviation airports when one or more of the slave ground receivers 104a-104i is located in close proximity to the small general aviation airport.

In some embodiments, the master ground station 102 emits a dedicated timing signal 118 to the slave ground receivers 104a-104i. In such embodiments, the aircraft receiver 304 of slave receiver 104 detects the timing signal and synchronizes the system time. The optional high resolution timer module 316 is configured to further facilitate control of the timing of the received timing signals 118 and the received interrogation reply signals 110a-110i.

It is appreciated that the communicated interrogation reply signals 110a-110i are originated at the same time as the interrogation reply 106, and preferably, are the same emitted signal with portions of the emitted signal from the aircraft 108 travelling different directions and travelling for different times to the master ground station 102 and the plurality of slave ground receivers 104a-104i. For purposes of describing the various embodiments, component portions of the signal emitted from the aircraft 108 are separately described and illustrated as the interrogation reply signal 106 and the interrogation reply signals 110a-110i.

In some embodiments, the interrogation reply signal 106 and the interrogation reply signals 110a-110i is a squitter signal. The squitter signal may be periodically transmitted from the airborne aircraft 108. Accordingly, the interrogation signal transmitted form the master ground station 102 is optional for an ADS-B capable transponder equipped airborne aircraft, and/or is transmitted after receipt of the squitter signal.

When the interrogation reply signals 110a-110i are received, TOAs corresponding to the received interrogation reply signals 110a-110i are communicated to the master ground station 102. The communicated TOA information indicates the precise time that the respective interrogation reply signals 110a-110i were received at the respective ones of the slave ground receivers 104a-104i. In an exemplary embodiment, communication of the TOA information is managed by the master transceivers 302 at the slave ground receivers 104a-104i and the slave transceiver 204 at the master ground station 102.

The information corresponding to the received interrogation reply signals 110a-110i that is communicated to the master ground station 102, and optionally the timing signals 118a-118i, may be communicated using any suitable wire-based and/or wireless communication medium. Further, different communication media may be used. For example, the master ground station 102 may be communicatively coupled to the slave ground receiver 104a via a legacy telephony system, a coaxial cable, a fiber optic cable, or other suitable wire-based medium. As another example, if the slave ground receiver 104b is located in a remote location, the master ground station 102 may be communicatively coupled to the slave ground receiver 104b via a suitable wireless system, such as, but not limited to, a radio frequency (RF) system or an infrared system.

The processing system 208, executing the TDOA/RTDT calculation module 222, performs TDOA and/or RTDT calculations based on the time that the interrogation reply signal 106 is received (and/or the time ADS-B squitter signal is received) at the aircraft transceiver 206 at the master ground station 102, and the time that the interrogation reply signals 110a-110i are received (and/or the time ADS-B squitter signal is received) at the aircraft receivers 304 at the slave ground receivers 104a-104i.

The TOA_{M} is derived from the time of the interrogation reply signal 106 that is received by aircraft transceiver 206 at the master ground station 102. The TDOA_{SaM} is derived from TOA_{Sa}, which is the time of the interrogation reply 110a that is received by aircraft receiver 304 at slave ground receiver 104a, wherein TDOA_{SaM}=TOA_{Sa}−TOA_{M}.

Similarly, the TDOA_{SbM} is derived from TOA_{Sb}, the time of the interrogation reply signal 110b received by aircraft receiver 304 at slave ground receiver 104b, wherein TDOA_{SbM}=TOA_{Sb}−TOA_{M}. The TDOA_{SaSb} is derived from TOA_{Sa} and TOA_{Sb}, wherein TDOA_{SaSb}=TOA_{Sa}−TOA_{Sb}. Optionally, the TDOAs_{SiM} and TDOA_{SiSj} are derived from TOA_{Si}, TOA_{M}, and TOA_{Si}, TOA_{Sj}, respectively.

The round trip delay time (RTDT_{SaM}) corresponds to the time that the interrogation signal was transmitted from the master ground station 102 and the interrogation reply signal 110a is received at the slave ground receiver 104a-104i. RTDT_{SaM} is derived from time of transmit (TOT) which corresponds to the time of the interrogation signal is transmitted from the master station 102, and TOAs_{Sa}, which corresponds to the time that the interrogation reply signal 110a is received by aircraft receiver 304 at slave ground receiver 104a. Accordingly, RTDT_{SaM}=TOA_{Sa}−TOT.

Similarly, the RTDT_{SbM} is derived from TOT, and TOA_{Sb}, which corresponds to the time that the interrogation reply signal 110b is received by aircraft receiver 304 at slave ground receiver 104b. Accordingly, RTDT_{SbM}=TOA_{Sb}−TOT. Optionally, the RTDT_{SiM} is derived from TOA_{Si} and TOT.

The processing system 208, executing the elliptical and/or multilateration module 218, performs multilateration calculations and/or elliptical calculations to determine the location 116 of the airborne aircraft using at least the TDOAs, and the RTDTs when available.

When altitude information is received in the interrogation reply signal 106 and/or 110a-110i, and/or is received in a squitter signal, the location 116 of the aircraft 108 may be determined in three dimensional (3-D) space by multilateration calculations based on TDOA_{SaM}, TDOA_{SbM}, TDOA_{SaSb}. Moreover, the solution of the airborne aircraft location 116 can be optimized by elliptical calculations based on RTDT_{SaM}, RTDT_{SbM} for interrogation reply signal 106 and/or 110a-110i.

If altitude information is not available, then the location 116 of the aircraft 108 may be determined in two-dimensional (2D) space.

A more accurate determination of the location 116 of the aircraft 108 may then be determined by using parameters from the additional slave ground receivers 104i.

The decoded position from a received ADS-B position squitter is determined at the master ground station 102 for an ADS-B capable transponder equipped airborne aircraft. The location 116 can be verified with parameters from two or more slave ground receivers 104a-104i by calculated position determined as described above.

In some embodiments, a decoded position of the airborne aircraft 108 may be verified based upon the calculated 2-D or 3-D location 116 determined by the short baseline positioning system 100. The position of the aircraft 108 is decoded from information received from the aircraft 108. Further, the decoded position of the airborne aircraft may be tracked if the verification passed based upon the calculated 2-D or 3-D location 116.

In some embodiments, a plurality of the interrogation signals are communicated from the master ground station 102 at pre-defined scheduled time windows. Accordingly, the plurality slave ground receivers 104a-104i track the time of communication of the plurality of the interrogation signals for time synchronization.

Output interfaces 210, 308 are provided to enable service personnel or other electronic systems to receive the aircraft location information determined by embodiments of the short baseline positioning system 100. In some embodiments, the interfaces 210 and/or 308 provide information to an air traffic control system. The determined aircraft location information may then be integrated with other available air traffic control information.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for locating an airborne aircraft, the method comprising:
communicating an interrogation signal to the airborne aircraft from a master ground station, the interrogation signal communicated at a time of transmit (TOT) from the master ground station;
receiving a first interrogation reply signal from the airborne aircraft at the master ground station;
determining a first time of arrival (TOA) using the first interrogation reply signal;
receiving a second interrogation reply signal at a first slave ground station;
determining a second TOA using the second interrogation reply signal;
receiving a third interrogation reply signal at a second slave ground station;
determining a third TOA using the third interrogation reply signal; and
determining at least a two dimensional location of the airborne aircraft based on at least one of a multilateration calculation and an elliptical calculation using three derived difference time of arrivals (DTOAs) and two derived round trip delay times (RTDTs) determined from the TOT, the first TOA, the second TOA, and the third TOA.

2. The method of claim 1, further comprising:
receiving altitude information of the airborne aircraft in at least one of the received first interrogation reply signal, the second interrogation reply signal and the third interrogation reply signal; and
determining a three dimensional location of the airborne aircraft based on the multilateration calculation using the TOT, the first TOA, the second TOA, the third TOA, and the altitude information.

3. The method of claim 2, further comprising:
receiving a fourth interrogation reply signal at a third slave ground station;
determining a fourth TOA using the fourth interrogation reply signal; and
determining a more accurate location of the airborne aircraft based on the at least one of the multilateration calculation and the elliptical calculation using six derived DTOA and three derived RTDT from the TOT, the first TOA, the second TOA, the third TOA and the fourth TOA.

4. The method of claim 1, wherein communicating the interrogation signal to the airborne aircraft from the master ground station comprises:
emitting an interrogation radar signal towards the airborne aircraft from the master ground station,
wherein the first interrogation reply signal, the second interrogation reply signal, and the third interrogation reply signal are emitted from the airborne aircraft in response to the emitted radar signal being incident on the airborne aircraft.

5. The method of claim 1, further comprising:
receiving the interrogation signal at the first slave ground receiver and the second slave ground receiver,
wherein the received interrogation signal is associated with a time that the interrogation signal is communicated, and
wherein the second interrogation reply signal and the third interrogation reply signal are associated with the time.

6. The method of claim 1, wherein the first interrogation reply signal, the second interrogation reply signal, and the third interrogation reply signal are portions of a reply signal emitted from the airborne aircraft in response to the airborne aircraft receiving the interrogation signal.

7. A method for locating an automatic dependent surveillance-broadcast (ADS-B) capable transponder equipped airborne aircraft, the method comprising:
passively listening at a master ground station and a plurality of slave ground receivers for an ADS-B squitter from the airborne aircraft;
decoding a received position squitter at the master ground station; and
determining a position of the airborne aircraft by aircraft position reports.

8. The method of claim 7, wherein the plurality of slave ground receivers comprises a first slave ground receiver and a second slave ground receiver, and further comprising:
receiving a first squitter signal at the master ground station;
determining a first time of arrival (TOA) using the first squitter signal;
receiving a second squitter signal at the first slave ground station;
determining a second TOA using the second squitter signal;
receiving a third squitter signal at the second slave ground station;
determining a third TOA using the third squitter signal; and
determining at least a two dimensional location of the airborne aircraft based on a multilateration calculation using three derived difference time of arrivals (DTOAs) determined from the first TOA, the second TOA, and the third TOA.

9. The method of claim 8, wherein the plurality of slave ground receivers comprises a third slave ground receiver, and further comprising:
receiving a fourth squitter signal at the third slave ground station;
determining a fourth TOA using the fourth squitter signal; and
determining a more accurate location of the airborne aircraft based on the multilateration calculation using six derived DTOAs determined from the first TOA, the second TOA, the third TOA and the fourth TOA.

10. The method of claim 8, further comprising:
verifying a decoded position of the airborne aircraft based upon the two dimensional position; and
tracking the decoded position of the airborne aircraft if the verification passed based upon the calculated two dimensional position and decoded altitude information from the airborne aircraft tracking.

11. An airborne aircraft location determination system, comprising:
a master ground station configured to emit an interrogation signal to an airborne aircraft, and configured to receive at least one of a first interrogation reply signal and a first squitter signal from the airborne aircraft;
a first slave ground station configured to receive the interrogation signal from the master ground station, configured to receive at least one of a second interrogation reply signal and a second squitter signal from the airborne aircraft, and configured to communicate first information associated with the received at least one of the second interrogation reply signal and the second squitter signal to the master ground station; and
a second slave ground station configured to receive the interrogation signal from the master ground station, configured to receive at least one of a third interrogation reply signal and a third squitter signal from the airborne aircraft, and configured to communicate second information associated with the received at least one of the third interrogation reply signal and the squitter signal to the master ground station,
wherein a time of transmit (TOT) of the interrogation signal is determined at the master ground station,
wherein a first time of arrival (TOA) is determined using the at least one of the first interrogation reply signal and the first squitter signal,
wherein a second TOA is determined using the first information associated with the at least one of the second interrogation reply signal and the second squitter signal,
wherein a third TOA is determined using the second information associated with the at least one of the third interrogation reply signal and the third squitter signal, and
wherein a location of the airborne aircraft is determined based on at least one of a multilateration calculation and an elliptical calculation using the TOT, first TOA, the second TOA, and the third TOA.

12. The airborne aircraft location determination system of claim 11, further comprising:
a first transceiver residing at the master ground station, wherein the at least one of the first interrogation reply signal and the first squitter signal is a first portion of a radio frequency signal emitted by the airborne aircraft;
a second receiver residing at the first slave ground receiver, wherein the at least one of the second interrogation reply signal and the second squitter signal is a second portion of the radio frequency signal emitted by the airborne aircraft; and
a third receiver residing at the second slave ground receiver, wherein the at least one of the third interrogation reply signal and the third squitter signal is a third portion of the radio frequency signal emitted by the airborne aircraft.

13. The airborne aircraft location determination system of claim 12, wherein the interrogation signal is a radio frequency interrogation signal emitted by the first transceiver.

14. The airborne aircraft location determination system of claim 12, wherein the radio frequency interrogation signal emitted by the first transceiver is received by the second receiver residing at the first slave ground receiver and is received by the third receiver residing at the second slave ground receiver, wherein the received radio frequency interrogation signal is associated with a time that the interrogation signal is communicated using pre-defined time windows, and wherein the second interrogation reply signal and the third interrogation reply signal are associated with the time.

15. The airborne aircraft location determination system of claim 11, wherein the first interrogation reply signal, the second interrogation reply signal, and the third interrogation reply signal are portions of a reply signal emitted from the airborne aircraft in response to the airborne aircraft receiving the interrogation signal.

16. The airborne aircraft location determination system of claim 11, wherein the first squitter signal, the second squitter signal, and the third squitter signal are portions of a squitter signal emitted from the airborne aircraft.

17. The airborne aircraft location determination system of claim 11, further comprising:
a third slave ground station configured to receive the interrogation signal from master station, configured to receive at least one of a fourth interrogation reply signal and a fourth squitter signal from the airborne aircraft, and configured to communicate third information associated with the at least one of the received fourth interrogation reply signal and the fourth squitter signal to the master ground station,
wherein a fourth TOA is determined using the at least one of the fourth interrogation reply signal and the fourth squitter signal, and
wherein a more accurate location of the airborne aircraft is determined based on at least one of the multilateration calculation and the elliptical calculation using the TOT, first TOA, the second TOA, the third TOA and the fourth TOA.

18. The airborne aircraft location determination system of claim 11,
wherein altitude information of the airborne aircraft is determined from at least one of the first interrogation reply signal and the first squitter signal, at least one of the second interrogation reply signal and the second squitter signal, and at least one of the third interrogation reply signal and the third squitter signal, and
wherein a three-dimensional location of the airborne aircraft is determined based on at least one of the multilateration and the elliptical calculation using the TOT, the first TOA, the second TOA, the third TOA, and the altitude information.
